(19) United States
(12) Patent Application Publication
(10) Pub. No.: US 2009/0064715 A1
(43) Pub. Date: Mar. 12, 2009

(54) Method and device for drawing a tubular strand of quartz glass

(75) Inventors: Roland Horn, Aschaffenburg (DE); Helmut Leber, Hanau (DE); Martin Trommer, Schluechtern (DE); Nigel Whippey, Seligenstadt (DE); Rainer Berg, Langenselbold (DE); Joerg Becker, Niddatal (DE); Rolf Gerhardt, Hammersbach (DE)

Correspondence Address: TIAJOLOFF & KELLY, CHRYSLER BUILDING, 37TH FLOOR, 405 LEXINGTON AVENUE, NEW YORK, NY, 10174, US

(73) Assignee: Heraeus Quarzglas GmbH & Co. KG, Hanau (DE)

(21) Appl. No.: 11/920,370

(22) PCT Filed: Mar. 7, 2007
(86) PCT No.: PCT/EP2007/052119

§ 371 Date: Nov. 14, 2007

(30) Foreign Application Priority Data
Mar. 10, 2006 (DE) 10 2006 011 579.1

(51) Int. Cl. C03B 23/047

(52) U.S. Cl. 65/32.5; 65/187

(57) ABSTRACT

In a known method for drawing a tubular quartz glass strand, a crucible is fed with SiO₂-containing start material, the start material is softened in the crucible and, as a softened quartz glass mass, is drawn vertically downwards as a tubular quartz glass strand along a drawing axis through an annular gap between an outer member and an inner member, which is arranged in a through hole of the outer member, of a drawing nozzle provided in the bottom area of the crucible. To improve the known method with respect to less inhomogeneity in the drawn-off tubular strand and thereby to permit the manufacture of homogeneous, defect-free hollow cylinders of quartz glass by drawing from the melt, it is suggested according to the invention that the inner member of the drawing nozzle, viewed in the direction of the drawing axis, is held suspended and radially movable inside the through hole of the outer member, and that the annular gap of the drawing nozzle has a longitudinal section “L” in which its cross-sectional nozzle area is reduced in size from the top to the bottom.

The present invention relates to a method for drawing a tubular quartz glass strand in that a crucible is fed with SiO₂-containing start material, said start material is softened in said crucible and, as a softened quartz glass mass, is drawn vertically downwards as a tubular quartz glass strand along a drawing axis through an annular gap between an outer member and an inner member, which is arranged in a through hole of the outer member, of a drawing nozzle provided in the bottom area of the crucible.

Furthermore, the present invention relates to a device for drawing a tubular quartz glass strand, comprising a crucible for receiving SiO₂-containing start material, the crucible being surrounded by a heater for softening the start material, and a drawing nozzle which is provided in the bottom area of the crucible and which comprises an outer member and an inner member arranged in a through hole of the outer member leaving an annular gap.

DE 103 37 388 A1 discloses a crucible pulling method and a device for producing a quartz glass strand according to the above-mentioned type. A quartz glass mass softened in a crucible is here pulled vertically downwards continuously via a drawing nozzle used in a bottom opening of the crucible so as to obtain a hollow cylindrical quartz glass strand of a predetermined profile. At the lower end of the drawing nozzle an exchangeable attachment nozzle is mounted that is connected to a hollow mandrel which projects into the attachment nozzle opening and through which a gas stream can be introduced into the inner bore of the quartz glass strand. The annular gap between the outer jacket of the mandrel and the inner wall of the attachment nozzle defines the profile of the tubular strand exiting out of the nozzle.

The mandrel is fixed in the attachment nozzle opening by means of a plurality of webs which are connected to the surrounding edge of the attachment nozzle. The webs are positioned in the stream of the glass exiting through the nozzle opening and divide said stream. This results in inhomogeneities in the drawn-off quartz glass strand, also because of the comparatively high viscosity of the quartz glass mass, which makes a trouble-free remelting of said portions more difficult.

One of the webs simultaneously forms the gas supply line to the mandrel via which a gas stream can be introduced into the inner bore of the tubular strand to be drawn off in order to regulate the diameter or the wall thickness of the tube by setting the blow pressure.

A further crucible pulling method for making a quartz glass tube and a device of the above-mentioned type are described in EP 394 640 A1. In this case, too, a drawing nozzle with an annular gap between outer ring and inner ring is provided for drawing a tubular quartz glass strand. The outer ring is inserted into a bottom opening of the crucible. The inner ring is centered relative to the outer ring by means of connection struts, also called “fingers” in technical language. A gas supply tube projects through the central bore of the inner ring, the gas supply tube immersing from above into the glass melt and a gas stream being introducible via said tube into the inner bore of the drawn-off tubular strand.

Hence, in this method the soft quartz glass mass also flows around the connection struts between outer ring and inner ring, it is divided in this process and may thus show the above-mentioned defects in the high-viscosity quartz glass mass exiting in the form of a strand out of the nozzle.

U.S. Pat. No. 3,508,900 A describes a method for drawing a quartz glass tube from the crucible, wherein an inner member of the drawing nozzle is held suspended from a shaft inside the through hole of an outer member of the drawing nozzle. The position of the inner member of the drawing nozzle is variable. To this end the upper end of the shaft is held on a positioning means comprising a ball joint. The drawing nozzle comprises an hour-glass-type upper member which is connected via an intermediate ring to a lower frustoconical member which extends up and into the opening formed by the outer member of the drawing nozzle.

U.S. Pat. No. 4,523,939 also describes a method for drawing a tubular quartz glass strand from a crucible, the melt exiting via a nozzle formed by an outer member and an inner member. The inner member is held suspended from a hollow shaft consisting of a refractory metal and it has a bulge which tapers downwards. This yields an annular gap of the drawing nozzle which tapers downwards over a certain longitudinal section.

It is the object of the present invention to improve the known method with the aim to achieve a smaller degree of inhomogeneity in the drawn-off tubular strand so as to permit the manufacture of homogeneous and defect-free hollow cylinders of quartz glass by drawing from the melt.

Furthermore, it is the object of the present invention to provide a constructionally simple device which can be realized with little effort and which entails the above-mentioned improvements of the method.

As for the method, the object starting from the above-mentioned method is achieved according to the invention in that that the inner member of the drawing nozzle, viewed in the direction of the drawing axis, is held suspended and radially movable inside the through hole of the outer member, and that the annular gap of the drawing nozzle has a longitudinal section “L” in which its cross-sectional nozzle area is reduced in size from the top to the bottom.

It has been found that the quartz glass tubes produced by means of the known methods have defects at the contact points with the connection struts, said defects being visible during heating as finely afterglowing lines. Upon inflation of such quartz glass tubes for increasing the inner bore, wall thickness variations are often observed exactly with the rotational symmetry of the “fingers”.

Attention must here be paid that the drawing nozzle on the whole or at least the parts of the drawing nozzle that get into contact with the hot quartz glass mass consist of molybdenum, tungsten, iridium, rhenium or other high-melting metals or alloys. It must be assumed that metal passes by abrasion into the glass mass and contributes to the above-explained defects. Most of the contact surfaces between the hot quartz glass mass and the drawing nozzle are later found on the surface of the drawn-off tubular strand from where they can be easily removed at a later time. This, however, is not true for the contact surfaces with the connection struts, for these are enclosed in the interior of the quartz glass tube.

The invention is therefore based on the finding that said defects should be avoided by entirely omitting the “fingers” of the inner member of the drawing nozzle. The “fingers” serve to center the inner member in the through hole of the outer member and to set the width of the annular gap. According to the invention a “passive” and inherent self-centering of the inner member is therefore aimed at, in the case of which both centering aids and an active centering of the inner member of the drawing nozzle can be dispensed with. It has been found that this can be realized under the preconditions that will be explained in more detail in the following:

1. The inner member of the drawing nozzle is held to be radially movable inside the through hole of the outer member of the drawing nozzle. The passive inherent self-centering mechanism requires some kind of movability of the inner member of the drawing nozzle with a movement component in a direction perpendicular to the drawing axis, which is here called “radial movability”. This movability can be ensured by the horizontal displaceability of the inner member or also by a suspended mounting which permits a free pendulum movement in a direction perpendicular to the drawing axis.
2. Furthermore, it is essential that the annular gap between inner member and outer member in the direction of the drawing axis is provided at least over part of its total length with a longitudinal section “L” in which its cross-sectional nozzle area is reduced from the top to the bottom. This reduction of the cross-sectional nozzle area may be due to a continuous or stepwise narrowing of the annular gap from the top to the bottom and/or, in the case of an annular gap with a constant annular gap width, by the diameter of the annular gap decreasing in size from the top to the bottom. In the last-mentioned variant, the annular gap is defined by walls that are in parallel with one another and enclose an angle between 0° and 90° with the drawing axis, so that the annular gap extends in the direction of the drawing axis.

Of decisive importance to self-centering are the pressure conditions around the inner member of the drawing nozzle. When looking at the pressure curve in the direction of the drawing nozzle, one will notice that the pressure in the interior of the crucible increases from the top to the bottom and then decreases again inside the drawing nozzle down to atmospheric ambient pressure. Two different mechanisms form the background for this: The one is the “hydrostatic” pressure of the quartz glass mass (gravity pressure); the other mechanism is the pressure decrease in flow direction which is associated with the flow of the viscous quartz glass mass. The gradient of this pressure decrease is particularly pronounced in regions where the quartz glass mass flows through narrow sections (such as the drawing nozzle) of an otherwise wide cavity (such as the crucible interior). For these reasons the effect of pressure increase by the hydrostatic pressure of the quartz glass mass prevails in the crucible interior from the top to the bottom, whereas the conditions in the drawing nozzle are inverted, and the pressure decrease from the top to the bottom constitutes the prevailing effect.

In a cylindrical annular gap with parallel boundary walls and constant diameter the gap width in the case of a radially deflected inner member is broader at the one side than at the opposite side. Although on account of the lower flow resistance more quartz glass mass flows through the broader gap region than at the other side, the pressure decrease in vertical direction is the same at both sides, so that no pressure component is formed in radial direction. An annular gap with cylinder geometry therefore exerts no radial force on the inner member and has no centering effect.

By contrast, in an annular gap having a downwardly narrowing cross-section and in the case of a radially deflected inner member a smaller pressure decrease is observed in vertical direction in the narrower gap region than in the wider gap region (upon comparison of the pressures at the same level). This pressure field around the inner member that is not rotationally symmetrical results in a force acting in radial direction that exerts a restoring force for the setting of a rotationally symmetrical pressure field and, together with this, a centering action on the inner member.

Inversely, an annular gap with a downwardly increasing cross-sectional area can act in a defined de-centering manner on a radially freely movable inner member in the through hole of the outer member.

These considerations disregard the effect of an increase in the viscosity of the quartz glass mass with the temperature decreasing downwards on the drawing nozzle. This effect can clearly be noticed quantitatively without changing the above-explained principle in general.

Self-centering of the inner member of the drawing nozzle inside the through hole of the outer member therefore requires an annular gap which at least over part of its length, which is here called longitudinal section “L”, comprises a cross-sectional area downwardly decreasing in size.

The decrease in the cross-sectional area can be achieved through the geometry of the through hole of the outer member of the drawing nozzle and/or the outer jacket of the inner member.

In a particularly preferred variant of the method, the cross-sectional area is reduced in that the annular gap narrows over at least part of the longitudinal section “L” from the top to the bottom.

The self-centering effect is here particularly great. It is increasing with an increasing degree of the constriction from the top to the bottom.

There are many appropriate options for forming the constriction of the annular gap. One is that the through hole of the outer member of the drawing nozzle narrows downwards.

The inner member of the drawing nozzle may here be cylindrical, it may be configured to taper or increase downwards, thereby contributing in addition to the narrowing of the annular gap. The gap width of the annular gap can be set by lifting or lowering the inner member of the drawing nozzle.

As an alternative, and equally preferred, the inner member of the drawing nozzle is enlarged downwards, thereby forming a downwardly narrowing annular gap.

The through hole of the outer member may here be configured such that it is cylindrical and tapers or increases in size downwards.

In this connection it has also turned out to be useful when the width of the annular gap decreases over its length by at least 20% of its maximum width.

At a given deflection of the inner member, the difference between maximal and minimal width of the annular gap over its constricted area has an effect on the magnitude of the resulting centering force. The greater this gap width difference is, the larger is also the maximal restoring force acting in vertical direction relative to the drawing axis on the inner member (=pressure difference). The greater this restoring force is, the better is the control sensitivity and the more exact is the self-centering of the inner member of the drawing nozzle. At a gap width difference of at least 20% (based on the maximal annular gap width), a control sensitivity that is particularly high as well as an exact self-centering of the inner member of the drawing nozzle are ensured.

In another preferred variant of the method, the cross-sectional area of the annular gap is decreasing from the top to the bottom in that the annular gap is enclosed over at least part of the longitudinal section “L” by parallel side walls, with the inner diameter of the annular gap and thus also the outer diameter decreasing from the top to the bottom.

It is true that the gap width of the annular gap does not change here. Nevertheless, with a decreasing inner diameter of the annular gap its cross-sectional area is decreasing from the top to the bottom. The boundary walls of the annular gap extend here in such a manner that they enclose an angle between 10° and 80° with the drawing axis, preferably an angle between 30° and 60°. Thus the annular gap extends from the top to the bottom in inclined fashion in the direction of the drawing axis.

In comparison with the embodiment with a narrowing annular gap, as has been explained above, this variant of the method shows a particular advantage. With a narrowing annular gap the centering effect is the more pronounced the stronger the narrowing degree is from the top to the bottom. The minimum gap width is substantially determined by the given wall thickness of the component to be drawn off. To achieve a distinct gradient of the gap width, a gap width that is as large is possible is therefore desired in the upper region of the annular gap. This is particularly true at a short length of the longitudinal section “L”. A large gap width in the upper region of the annular gap influences, however, the nozzle resistance. Said resistance is defined by the ratio of the mass throughput and the prevailing hydrostatic pressure of the quartz glass mass. The larger the gap width is in the upper region under otherwise identical conditions, the lower is the nozzle resistance. A change in the nozzle resistance, however, normally requires an undesired adaptation of other drawing parameters, particularly the temperature and thus the viscosity of the quartz glass mass.

This problem is attenuated by the preferred method variant with a constant gap width of the annular gap.

The advantages of the two method variants can be combined in that in an upper region of the longitudinal section “L” an annular gap is provided with a constant gap width and a decreasing inner diameter, which in a lower portion of the longitudinal section “L passes into a narrowing annular gap.

It has turned out to be advantageous when the longitudinal section “L” has a length of at least 10 mm, preferably at least 15 mm.

The length of the longitudinal section “L” has an effect on the magnitude of the pressure gradient over the annular gap. At a given hydrostatic pressure by the soft quartz glass mass a smaller mean pressure gradient is observed in the case of a long longitudinal section “L” of the annular gap than in the case of a short longitudinal section “L”. A steep pressure gradient leads to reduced control sensitivity, thereby rendering an exact self-centering of the inner member of the drawing nozzle more difficult. At a longitudinal section “L”, starting from a length of 10 mm onwards, a control sensitivity that is particularly high as well as an exact self-centering of the inner member of the drawing nozzle are ensured.

The radially movable mounting of the inner member of the drawing nozzle can be accomplished through a horizontal displaceability of the mounting. In a particularly preferred embodiment of the method of the invention, the inner member of the drawing nozzle is held on a holding element extending upwards through the softened quartz glass mass, which has an outer diameter of not more than 40 mm and a length of not more than 100 cm.

In the case of a rigid or deflection-resistant holding element or small restoring forces, the radial movement of the inner member can be achieved through free displaceability of the holding element in horizontal direction, or in that the lower end can perform a free reciprocating movement around an upper holding point. With less rigid holding elements, elastic deformability could also be enough for an adequate movability of the inner member for self-centering. The holding element is for instance a linkage or a cylindrical body, such as a rod, a tube or a wire.

A holding element with the above-mentioned dimensions normally exhibits an adequately low bending stiffness which permits a certain pendulum movement and thus an adequate radial displacement of the inner member fixed to its one end inside the through hole of the outer member. Other complicated constructional transport mechanisms for ensuring an axial movability of the inner member of the drawing nozzle can thus be dispensed with.

Furthermore, it turns out to be advantageous when the inner member of the drawing nozzle comprises a central bore which is in fluid communication with an inner bore of the holding element.

The holding element used for holding the inner member of the drawing nozzle is here simultaneously used for introducing a process gas which is fed into the inner bore of the quartz glass strand to be drawn off.

A procedure has turned out to be particularly useful in which the softened quartz glass mass produces a hydrostatic pressure of at least 180 mbar.

An efficient self-centering of the inner member of the drawing nozzle requires a certain pressure drop over the length of the annular gap. The greater this pressure drop is, the stronger is, at the given narrowing of the annular gap, the restoring force acting on the inner member upon deflection. The pressure drop inside the drawing nozzle corresponds to the hydrostatic pressure of the quartz glass mass. In case of a pressure drop of 180 mbar a particularly efficient restoring force can be provided. It turns out to be advantageous when the softened quartz glass mass flows through the annular gap at a flow rate between 12 kg/h to 45 kg/h, preferably between 20 kg/h to 35 kg/h.

The configuration of the passive and inherent force centering mechanism for centering the inner member of the drawing nozzle requires a certain flow of the quartz glass mass. A flow of the quartz glass mass in the above cited region causes the nozzle to establish a flow resistance which is most suitable for the passive, inherent self centering mechanism of the present invention.

Furthermore, a procedure is preferred in which the softened quartz glass mass, based on the minimal cross-sectional area of the annular gap, flows at a flow rate of at least 0.3 kg/h cm² through the annular gap of the drawing nozzle.

With regard to the minimal cross-sectional area of the annular gap, particularly efficient restoring forces are created at flow rate of at least 0.3 kg/h per cm².

As for the device, the above-mentioned object starting from a device of the above-mentioned type is achieved according to the invention in that a holding element is provided from which the inner member of the drawing nozzle, viewed in the direction of the drawing axis, is held suspended and radially movable inside the through hole of the outer member, and that the annular gap of the drawing nozzle has a longitudinal section “L” along which the cross-sectional nozzle area of the annular gap is reduced in size from the top to the bottom.

The device serves to carry out the above-explained method of the invention. Disorders in the drawn-off quartz glass strand are avoided in that both an active centering of the inner member of the drawing nozzle by way of positioning means and centering aids, such as a centering of the inner member of the drawing nozzle by means of “fingers”, are dispensed with, and instead of this a passive self-centering of the inner member is permitted. This is accomplished with the following measures:

1. The inner member of the drawing nozzle is held suspended from a holding element to be radially movable within the through hole of the outer member of the drawing nozzle. This helps to achieve some movability of the inner member of the drawing nozzle with a movement component in a direction perpendicular to the drawing axis in an easy way.

With a rigid holding element or in the case of small restoring forces this movement can be accomplished by way of a free displaceability of the holding element in horizontal direction, or in that the lower end can perform a free pendulum movement about an upper holding point. In the case of holding elements that show less bending stiffness the elastic deformability may suffice for an appropriate movability of the inner member for passive, inherent self-centering. The holding element is for instance a linkage or a cylindrical body, such as a rod, tube or wire.

2. The annular gap between inner member and outer member comprises a longitudinal section “L” in which its cross-sectional nozzle surface is reduced from the top to the bottom. The reduction of the cross-sectional nozzle area may be due to a continuous or stepwise constriction of the annular gap from the top to the bottom and/or in the case of an annular gap with constant annular gap width due to the fact that the diameter of the annular gap is decreasing from the top to the bottom. In the last-mentioned variant, the annular gap is defined by walls that are in parallel with each other and enclose an angle between 0° and 90° with the drawing axis.

Due to the reduction of the cross-sectional nozzle area from the top to the bottom a smaller pressure decrease is accomplished in vertical direction in the case of a coaxially de-centered inner member in the narrower gap region than in the wider gap region. This pressure field that is not rotationally symmetrical around the inner member results in a pressure component in radial direction that exerts a restoring force for the adjustment of a rotationally symmetrical pressure field and, together with this, a centering effect on the inner member.

The annular gap can be narrowed by the geometries of the through hole of the outer member of the drawing nozzle and/or the outer jacket of the inner member.

Advantageous developments of the device of the invention become apparent from the subclaims. Insofar as developments of the device as indicated in the subclaims imitate the procedures indicated in subclaims regarding the method of the invention, reference is made for supplementary explanation to the above observations on the corresponding method claims.

The invention shall now be described in more detail with reference to embodiments and a drawing. The drawing is a schematic view which shows in detail:

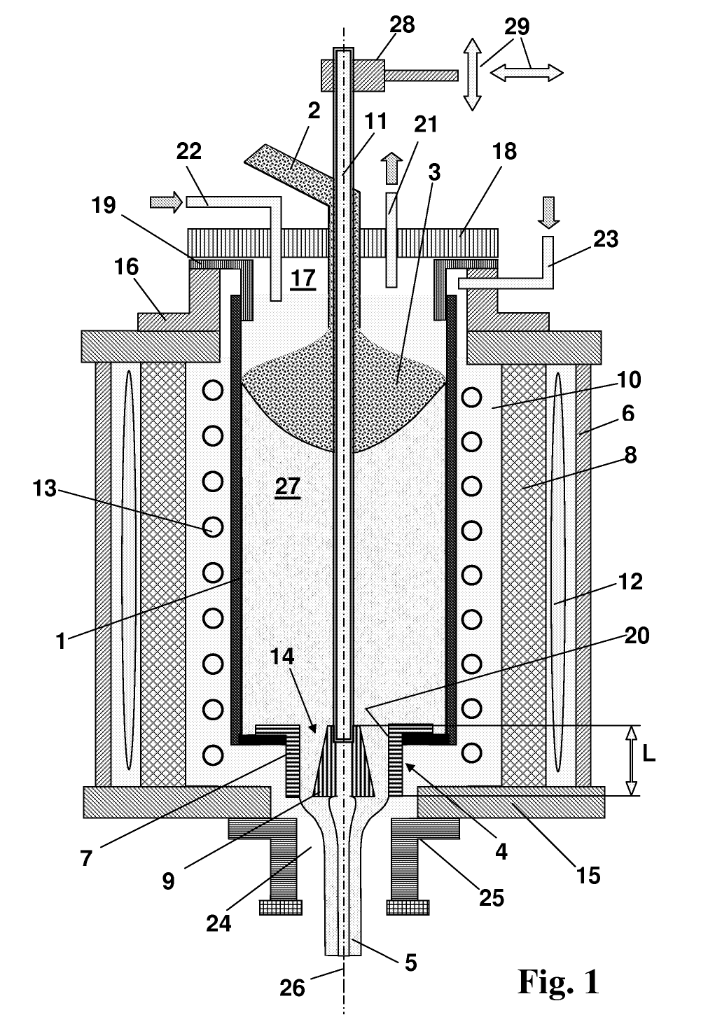

FIG. 1 an embodiment of the device according to the invention in the form of a drawing furnace with an inner member of the drawing nozzle held on a holder to be radially movable, and

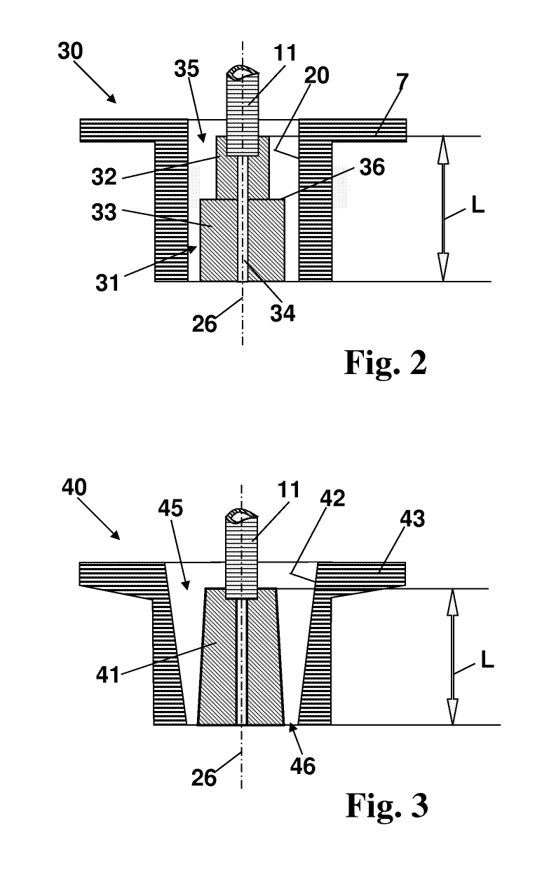

FIGS. 2 to 5 modifications of the embodiment of the drawing nozzle.

The drawing furnace according to FIG. 1 comprises a crucible 1 consisting of tungsten, into which SiO₂ granules 3 are continuously filled from above via a supply nozzle 2.

The crucible 1 is surrounded by a water-cooled (12) furnace jacket 6 with formation of a protective gas chamber 10 flushed with protective gas, which accommodates a porous insulating layer 8 of oxidic insulating material and a resistance heater 13 for heating the crucible 1. The protective gas chamber 10 is open downwards and, otherwise, sealed with a bottom plate 15 and a cover plate 16 to the outside. The crucible 1 encloses a crucible interior 17 which is also sealed to the environment by means of a cover 18 and a sealing element 19.

A drawing nozzle 4 of tungsten is provided in the bottom area of the crucible 1. The nozzle is composed of an annular outer member 7 of the drawing nozzle, which is used in the bottom of the crucible 1, and of an inner member 9 of the drawing nozzle, which is coaxially held in the cylindrical inner bore 20 of the outer member 7. The inner member 9 has a frustoconical outer jacket which tapers upwards. An annular gap 14 is therefore formed between outer member 7 and inner member 9, the annular gap narrowing from the top to the bottom and the soft quartz glass mass 27 being drawn off downwards through the annular gap in the direction of the drawing axis 26 as a tubular strand 5.

The diameter of the inner bore 7 of the outer member is 200 mm and its length is 100 mm. This corresponds to the length “L” of the annular gap 14 of the drawing nozzle 4, the width of which decreases from the top to the bottom from a maximum value of 30 mm to a minimum value of 20 mm.

The inner member 9 of the drawing nozzle 4 is connected to a holding tube 11 which extends through the quartz glass mass 27 and is guided through the upper cover 18 out of the crucible interior 17. The holding tube 11 consists of tungsten. It has a length of 160 cm, an outer diameter of 6 cm and an inner diameter of 1 cm. Apart from mounting the inner member 9 of the drawing nozzle, the holding tube 11 serves to supply a process gas for setting a predetermined blow pressure in the inner bore of the tubular strand 5. To this end the process gas is supplied to a through hole 25 formed in the inner member 9 of the drawing nozzle 4. The upper end of the holding tube 11 that is projecting out of the melting furnace is connected to a schematically illustrated height adjusting and displacing means 28 that, apart from height adjustment of the inner member 9 of the drawing nozzle, also permits a free displacement in lateral direction, as illustrated by the directional arrows 29. This movement permits a self-centering of the inner member 9 of the drawing nozzle inside the outer member of the drawing nozzle.

As an alternative, or in addition to the height adjusting and displacing means 28, the holding tube 11 is so flexible over its length of 160 cm that it permits an adequate lateral movability (pendulum movement) of the inner member 9 of the drawing nozzle. The bending stiffness of the holding tube depends on its wall thickness and on its outer diameter. In practice, an adequately low bending stiffness is given at outer diameters of not more 4 cm.

An inlet 22 and an outlet 21 for a crucible interior gas in the form of pure hydrogen project through the cover 18. Likewise, the protective gas chamber 10 is provided in the upper portion with a gas inlet 23 for pure hydrogen which can escape via the bottom opening 24 of the furnace jacket 6.

FIGS. 2 to 4 show schematic modifications of the drawing nozzle 5 within the scope of the invention on an enlarged scale. If the same reference numerals as in FIG. 1 are used, these refer to constructionally identical or equivalent components and parts of the device, as are explained in more detail above by way of the description of the first embodiment of the drawing furnace according to the invention.

The drawing nozzle 30 according to FIG. 2 consists of an outer member 8 of tungsten with a cylindrical inner bore 14 corresponding to the device shown in FIG. 1. In the inner bore 20, an inner member 31 of the drawing nozzle of tungsten is held by means of a tubular holder 11 such that it is coaxial to the longitudinal axis 26. The inner member 31 is composed of an annular upper member 32 with a smaller outer diameter and an annular lower member 33 with a larger outer diameter. The inner bore of the holder 11 terminates in the through hole 34 of the inner member 31.

The annular gap 35 between inner member 31 and outer member 7 thus narrows downwards in steps, step 36 being approximately provided in the center of the annular gap 35 (viewed over the annular gap length “L”). The inner diameter of the inner bore 20 is 60 mm, the annular gap 35 has a length “L” of 40 mm, its upper width is 15 mm, and its lower minimal width is 10 mm.

In the drawing nozzle 40 according to FIG. 3, the tubular holder 11 is connected to a conical inner member 41 of the drawing nozzle and is held by said member coaxially in the through hole 42 of an outer member 43 of tungsten. The through hole 42 narrows from the top to the bottom. Its maximum inner diameter is 80 mm, the minimum inner diameter is 60 mm, and its length is 60 mm.

The length of the conical inner member 41 corresponds approximately to the length of the through hole 52. Its upper minimum outer diameter is 30 mm, and the maximum outer diameter is 35 mm at the lower end. Thus the annular gap 45 narrows over its length “L” continuously from a maximum value of 25 mm to a minimum value of 12.5 mm in the area of the nozzle outlet 46.

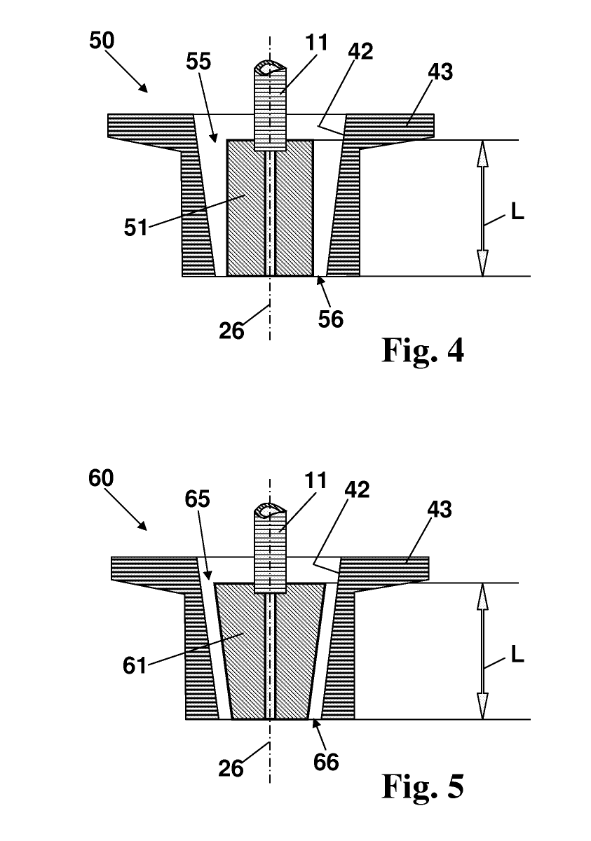

The drawing nozzle 50 according to FIG. 4 has an outer member 43 corresponding to that of the drawing nozzle shown in FIG. 3. In the through hole 42, a cylindrical inner member 51 of the drawing nozzle which is made of tungsten and has an outer diameter of 80 mm is held by means of the tubular holder 11.

The length of the cylindrical inner member 51 of 150 mm corresponds approximately to the length of the through hole 42. The outer diameter of the annular gap 55 thus decreases continuously over length “L” from a maximum value of 140 mm to a minimum value of 100 mm in the area of the nozzle outlet 56.

The drawing nozzle 60 according to FIG. 5 comprises an outer member 43 of the drawing nozzle corresponding to the drawing nozzle shown in FIG. 3. In the through hole 42, a conical inner member 61 of the drawing nozzle, which is made of tungsten, is held by means of the tubular holder 11. The conical shape of the inner member 61 of the drawing nozzle is such that the annular gap 65 between the inner member 61 and the outer member 43 has a constant gap width of 20 mm over its length “L” of 150 mm.

The outer diameter of the annular gap 65 decreases over the length “L” from a maximum value of 140 mm to a minimum value of 100 mm in the area of the nozzle outlet 66. In a further embodiment of the invention (not shown in a figure), a drawing nozzle is provided as shown in FIG. 5, except for the feature that the inner diameter of the outer member of the drawing nozzle is continuously reduced by 5 mm in the lower portion over a length of 20 mm as compared with the inner diameter of the outer member of the drawing nozzle according to FIG. 5, so that a gap width of the annular gap of 15 mm, which is reduced in comparison with FIG. 5, is obtained in the area of the nozzle outlet.

The method of the invention will now be described in the following with reference to an embodiment and FIG. 1.

SiO₂ granules 3 are continuously fed into the melting crucible 1 via the supply nozzle 2 and heated therein to a temperature of about 2100° C. to 2200° C. In this process a homogeneous glass mass 27 which is without bubbles and on which a grain layer of SiO₂ particles 3 is floating is formed in the lower portion of the crucible 1. The softened silica mass exits via the drawing nozzle 4 and the bottom opening 24 and is then drawn downwards in the form of a tubular quartz glass strand 5 and cut to pieces of a desired length.

The weight of the quartz glass mass 27 generates a “hydrostatic pressure” of about 200 mbar in the area of the crucible bottom, whereby the softened quartz glass mass passes through the annular gap 14 at a flow rate of about 28 kg/h.

Upon deflection of the inner member 9 of the drawing nozzle a pressure field that is not rotationally symmetrical is formed around the inner member 9 of the drawing nozzle due to the flowing quartz glass mass 27 and the constriction of the annular gap 14. This results in a restoring force acting on the inner member 9 towards a coaxial (26) centering. The amount of the restoring force depends on the amount of the deflection, the geometry of the annular gap 14 and the viscosity of the quartz glass mass 27. For a deflection of 5 mm the amount of the restoring force in a direction perpendicular to the longitudinal axis 26 can be assessed on the basis of the data given in the embodiment to be about 100 N. It has been found that, on account of its length, wall thickness and diameter, the holder 11 shows a bending stiffness so low that a restoring force in the above-mentioned order is enough for moving the inner member 9 mounted on the holder 11 in a direction perpendicular to the longitudinal axis 26 and for eliminating the deflection in this way.

In the drawing furnace and the method according to the invention, a self-centering drawing nozzle is used in the case of which connection struts (fingers) for centering the inner member of the drawing nozzle can be omitted, thereby permitting the drawing of high-quality quartz glass tubes from the melt.

1. A method for drawing a tubular quartz glass strand in that a crucible (1) is fed with SiO₂-containing start material (3), said start material is softened in said crucible and, as a softened quartz glass mass (27), is drawn vertically downwards as a tubular quartz glass strand (5) along a drawing axis (26) through an annular gap (14) between an outer member (7) and an inner member (9), which is arranged in a through hole (20) of the outer member (7), of a drawing nozzle (4) provided in the bottom area of the crucible (1), characterized in that the inner member (9) of the drawing nozzle, viewed in the direction of the drawing axis (26), is held suspended and radially movable inside the through hole (20) of the outer member (7), and that the annular gap (14) of the drawing nozzle has a longitudinal section “L” in which its cross-sectional nozzle area is reduced in size from the top to the bottom.

2. The method according to claim 1, characterized in that the annular gap (14) narrows from the top to the bottom over a least part of the longitudinal section “L”.

3. The method according to claim 1, characterized in that the through hole (20) of the outer member (7) of the drawing nozzle narrows downwards.

4. The method according to claim 1, characterized in that the inner member (9) of the drawing nozzle broadens downwards.

5. The method according to claim 1, characterized in that the width of the annular gap (14) decreases over its length by at least 20% of its maximum width.

6. The method according to claim 1, characterized in that the annular gap (14) is enclosed over at least part of the longitudinal section “L” by parallel side walls, the inner diameter of the annular gap (14) decreasing from the top to the bottom.

7. The method according to claim 1, characterized in that the longitudinal section “L” has a length of at least 10 mm, preferably at least 15 mm.

8. The method according to claim 1, characterized in that the inner member (9) of the drawing nozzle is held on a holding element (11) which extends upwards through the softened quartz glass mass (27) and which has an outer diameter of not more than 40 mm and a length of not more than 100 cm.

9. The method according to claim 8, characterized in that the inner member (9) of the drawing nozzle has a central bore (25) which is in fluid communication with an inner bore of the holding element (11).

10. The method according to claim 1, characterized in that the softened quartz glass mass (27) produces a hydrostatic pressure of at least 180 mbar.

11. The method according to claim 1, characterized in that the softened quartz glass mass (27) flows through the annular gap (14) at a flow rate between 12 kg/h to 45 kg/h, preferably between 20 kg/h to 35 kg/h.

12. The method according to claim 1, characterized in that the softened quartz glass mass (27), based on the minimal cross-sectional area of the annular gap (14) of the drawing nozzle, flows at a flow rate of at least 0.3 kg/h·cm² through the annular gap (14).

13. A device for drawing a tubular quartz glass strand, comprising a crucible (1) which is used for receiving SiO₂-containing start material (3) and is surrounded by a heater (13) for softening the start material (3), and a drawing nozzle (4) which is provided in the bottom area of the crucible (1) and which comprises an outer member (7) and an inner member (9) arranged in a through hole (20) of the outer member (7) leaving an annular gap (14), characterized in that a holding element (11) is provided from which the inner member (9) of the drawing nozzle, viewed in the direction of the drawing axis (26), is held suspended and radially movable inside the through hole (20) of the outer member (7), and that the annular gap (14) of the drawing nozzle has a longitudinal section “L” along which the cross-sectional nozzle area of the annular gap (14) is reduced in size from the top to the bottom.

14. The method according to claim 13, characterized in that the annular gap (14) of the drawing nozzle narrows from the top to the bottom at least along the longitudinal section “L”.

15. A device according to claim 13, characterized in that the through hole (20) of the outer member (7) of the drawing nozzle narrows downwards.

16. The device according to claim 13, characterized in that the inner member (9) of the drawing nozzle broadens downwards.

17. The device according to claim 13, characterized in that the width of the annular gap (14) decreases over its length by at least 20% of its maximum width.

18. The device according to claim 13, characterized in that the annular gap (14) of the drawing nozzle is enclosed over at least part of the longitudinal section “L” by parallel side walls, with the inner diameter of the annular gap (14) decreasing from the top to the bottom.

19. The device according to claim 13, characterized in that the length section “L” has a length of at least 10 mm, preferably at least 15 mm.

20. The device according to claim 13, characterized in that the holding element (11) has an outer diameter of not more than 40 mm and a length of not more than 100 cm.

21. The device according to claim 20, characterized in that the inner member (9) of the drawing nozzle has a central bore (25) which is in fluid communication with an inner bore of the holding element (11).
